(19) United States
(12) Patent Application Publication
(10) Pub. No.: US 2007/0074353 A1
(43) Pub. Date: Apr. 5, 2007

(54) Step pile fabric and process for producing the same

(76) Inventors: Minoru Kuroda, Hyogo (JP); Kohei Kawamura, Hyogo (JP); Sohei Nishida, Hyogo (JP); Masahiko Mihoichi, Hyogo (JP)

Correspondence Address: BRINKS HOFER GILSON & LIONE, P.O. BOX 10395, CHICAGO, IL, 60610, US

(21) Appl. No.: 10/583,242

(22) PCT Filed: Dec. 24, 2004
(86) PCT No.: PCT/JP04/19726

§ 371 Date: Jun. 16, 2006

(30) Foreign Application Priority Data
Dec. 26, 2003 (JP) 2003-435465

(51) Int. Cl. C11D 3/00

(52) U.S. Cl. 8/115.51; 428/85; 428/88; 428/92

(57) ABSTRACT

An increased number of colors can be assorted in the down hair part of a step pile fabric more easily than before by carrying out dry heat treatment of a pile fabric comprising an acrylic shrinkable fiber that can be dyed in a specific low-temperature region. There is provided a step pile fabric obtained by treating a pile fabric comprising an acrylic shrinkable fiber, which comprises comprising an acrylic copolymer comprising 0.5 to 10 wt % of a sulfonic acid group-containing monomer, dyed at 55 to 85° C., with dry heat at 110 to 150° C. for 20 minutes or less, the acrylic shrinkable fiber having a shrinkage percentage of 18% or more calculated by the following formula (1):
Shrinkage percentage (%)=100×(1−Sa/Sb) (1) wherein Sb represents a pile length of the down hair component before the dry heat treatment, and Sa represents a pile length of the down hair part (component) after the dry heat treatment.

### TECHNICAL FIELD

The present invention relates to a step(two-tone) pile fabric prepared using an acrylic shrinkable fiber dyed at 55 to 85° C. comprising an acrylic copolymer comprising 0.5 to 10 wt % of a sulfonic acid group-containing monomer, and a process for producing the same.

### BACKGROUND ART

Acrylic fibers have texture like animal hair, high flexibility and brilliant color appearance, for example, and thus have been widely used in knitting and for boas and high piles. Originally, natural fur has a two-layer structure composed of guard hair and down hair. Direct imitation of natural fur using a synthetic fiber produces pile goods. As means for achieving such a structure in pile goods, a method comprising causing a non-shrinkable fiber and a shrinkable fiber having different shrinkage percentages to be present in a pile part; causing the shrinkable fiber to shrink in the pile prefinishing step; and causing a step to appear in the pile part based on the difference in shrinkage percentage at that time is generally used. Typically, the shrinkable fiber used at this time produces a pile step by dry heat treatment using a pin tenter or the like to achieve a shrinkage percentage of 20 to 40%. Japanese Patent Laid-Open No. 61-12910, Japanese Patent Laid-Open No. 4-119114 and Japanese Patent Laid-Open No. 2003-268623 disclose highly shrinkable acrylic fibers used in pile goods as described above. However, fibers obtained by a production process disclosed in these documents cannot be sufficiently dyed at a low temperature of 80° C. or less and are thus poorly colored. On the other hand, when the fibers are dyed with boiling water at 98 to 100° C. and used in pile fabrics, the fibers cannot have a significant shrinkage percentage by subsequent dry heat treatment using a tenter.

Japanese Patent Laid-Open No. 6-158422 describes a technique for a process for producing an acrylic shrinkable fiber using, as a raw material, a polymer composition obtained by blending an acrylic copolymer with another acrylic copolymer. However, this technique is related to improvement in shrinking percentage and flame retardance of acrylic fibers, and is not immediately related to the present invention to obtain a step pile fabric using an acrylic shrinkable fiber dyed in a low-temperature region.

As described above, it is generally known that an acrylic fiber must be dyed at a temperature of 90° C. or more for normally dyeing and coloring the fiber. As a method for dyeing an acrylic fiber in a low-temperature region, Japanese Patent Publication No. 49-38945 proposes a method comprising dissolving a cationic dye in a solution of a halogenated aliphatic hydrocarbon compound and dyeing at a temperature of 80° C. or less. However, this method involves uneven dyeing by the cationic dye, adverse effects of the halogenated aliphatic hydrocarbon compound on wastewater, and generation of static electricity in the spinning process, for example. Thus, it is difficult to achieve normal processability in this method.

Japanese Patent Laid-Open No. 2002-266230 describes that a plush product obtained using a spun yarn made of an acrylic short fiber obtained by dyeing with a cationic dye at a temperature of 95° C. or less provides a plush fabric that has excellent dry heat polishing properties, has crimps capable of being well stretched, has soft and wet texture as goods, is bulky, and has excellent stiffness. However, a step pile fabric using an acrylic shrinkable fiber dyed in a low-temperature region is not described.

Further, Japanese Patent Laid-Open No. 8-325833 describes copolymerization of p-styrenesulfonic acid and/or its salt with an acrylic polymer to increase dyeability of the resulting fiber at a low temperature and increase the dyeing concentration. However, a pile fabric using a shrinkable fiber having a residual shrinkage percentage during dyeing at a low temperature or an acrylic shrinkable fiber that can shrink to a certain extent by dry heat treatment or the like is not described. In addition, the resulting fiber is extremely thin to have a size of 0.01 to 0.5 denier and is applicable only to clothes such as sweaters. Thus, the fiber differs from the fiber of the present invention in terms of the size range and application fields.

Accordingly, there has not been reported so far a pile fiber using an acrylic shrinkable fiber that can be dyed in a low-temperature region and can shrink to a certain extent by dry heat treatment using a pin tenter or the like. Consequently, in order to assort colors in the down hair part of a pile fabric, a spun-dyed shrinkable fiber must have been used so far.

### DISCLOSURE OF THE INVENTION

The present invention can increase number of colors assort in the down hair part of a step pile fabric more easily than before by carrying out dry heat treatment of a pile fabric comprising an acrylic shrinkable fiber that can be dyed in a specific low-temperature region.

The present invention relates to a step pile fabric obtained by treating a pile fabric comprising an acrylic shrinkable fiber dyed at 55 to 85° C. comprising an acrylic copolymer comprising 0.5 to 10 wt % of a sulfonic acid group-containing monomer with dry heat at 110 to 150° C. for 20 minutes or less, the acrylic shrinkable fiber having a shrinkage percentage of 18% or more calculated by the following formula (1):
Shrinkage percentage ( % )=100×(1−Sa/Sb) (1)

wherein Sb represents a pile length of the down hair component before the dry heat treatment, and Sa represents a pile length of the down hair part (component) after the dry heat treatment.

Preferably, the acrylic shrinkable fiber comprises an acrylic copolymer and is dyed with a cationic dye.

Preferably, the acrylic copolymer comprises 60 to 99 parts by weight of a copolymer (I) comprising 35 to 98 wt % of acrylonitrile, 0 to 5.0 wt % of a sulfonic acid group-containing monomer and 2 to 65 wt % of other vinyl monomer(s), and 1 to 40 parts by weight of a copolymer (II) comprising 0 to 90 wt % of acrylonitrile, 2 to 40 wt % of a sulfonic acid group-containing monomer and 0 to 80 wt % of other vinyl monomer(s), wherein the copolymers (I) and (II) are 100 parts by weight in total.

The present invention also relates to a process for producing the step pile fabric according to claim 1, 2 or 3, comprising the pile steps of: dyeing an acrylic shrinkable fiber comprising an acrylic copolymer comprising 0.5 to 10 wt % of a sulfonic acid group-containing monomer at 55 to 85° C.; blending the acrylic shrinkable fiber with a non-shrinkable fiber to produce a pile fabric; and treating the resulting pile fabric with dry heat at 110 to 150° C. for 20 minutes or less to cause the acrylic shrinkable fiber to have a shrinkage percentage of 18% or more.

The present invention provides a step pile fabric obtained by treating a pile fabric comprising an acrylic shrinkable fiber dyed at 55 to 80° C. comprising an acrylic copolymer comprising 0.5 to 10 wt % of a sulfonic acid group-containing monomer with dry heat at 110 to 150° C. for 20 minutes or less, the acrylic shrinkable fiber having a shrinkage percentage of 18% or more calculated by the above formula (1).

The acrylic copolymer in the present invention comprises 0.5 to 10 wt %, and preferably 1.0 to 5.0 wt % of a sulfonic acid group-containing monomer. If the content of the sulfonic acid group-containing monomer is less than 0.5 wt %, the fiber cannot be sufficiently dyed to medium to dark colors with a cationic dye, and thus cannot be well-colored. If more than 10 wt %, the fiber tends to be agglutinated in the spinning process and to have decreased coagulability in a coagulation bath.

Examples of the sulfonic acid group-containing monomer used in the present invention include sodium allylsulfonate, sodium methallylsulfonate, sodium vinylsulfonate, sodium styrenesulfonate and sodium 2-acrylamido-2-methylpropanesulfonate.

The acrylic copolymer in the present invention preferably comprises 60 to 99 parts by weight of a copolymer (I) comprising 35 to 98 wt % of acrylonitrile, 0 to 5.0 wt % of a sulfonic acid group-containing monomer and 2 to 65 wt % of other vinyl monomer(s), and 1 to 40 parts by weight a copolymer (II) comprising 0 to 90 wt % of acrylonitrile, 2 to 40 wt % of a sulfonic acid group-containing monomer and 0 to 80 wt% of other vinyl monomer(s) not containing halogen atom, wherein the copolymers (I:) and (II) are 100 parts by weight in total, and more preferably comprises 70 to 97 parts by weight of a copolymer (I) and 3 to 30 parts by weight of a copolymer (II). If the copolymer (II) is less than 1 part by weight, the resulting acrylic shrinkable fiber cannot be sufficiently colored in a low-temperature region. If more than 40 parts by weight, the fiber tends to have voids formed therein and to be agglutinated, disadvantageously.

The acrylonitrile content of the copolymer (I) is preferably 35 to 98 wt %, and more preferably 40 to 90 wt %. If the content is less than 35 wt %, the fiber has sticky texture and is not voluminous. If more than 98 wt %, the fiber has rough texture, has a decreased number of a dye-dyeing site, and thus tends to be poorly dyed. Here, the dyeing site refers to an adsorption site that can adsorb dye molecules. As the acrylonitrile content is smaller, the heat resistance of acrylic shrinkable fiber formed tends to be reduced. Accordingly, it is difficult to set the dry heat treatment temperature at a high temperature taking into consideration the effect of heat on the acrylic shrinkable fiber forming the pile part, and thus it is difficult to achieve a higher shrinkage percentage by dry heat treatment. As a result, it is difficult to finally obtain a step pile fabric having a significant pile step.

The content of the sulfonic acid group-containing monomer of the copolymer (I) is preferably 0 to 5.0 wt %, and more preferably 0.5 to 3 wt %. If the content is more than 5.0 wt %, the fiber tends to be agglutinated in the spinning process, undesirably.

Examples of the other vinyl monomer in the copolymer (I) include vinyl halides or vinylidene halides such as vinyl chloride, vinylidene chloride, vinyl bromide and vinylidene bromide; acrylic acid, methacryl acid or their alkyl esters; vinyl acetate, acrylamide, 2-hydroxyethyl methacrylate, 2-hydroxyethyl acrylate, glycidyl methacrylate and glycidyl acrylate. The content of the other vinyl monomer in the copolymer (I) is preferably 2 to 65 wt %, and more preferably 5 to 55 wt %. If the content is less than 2 wt %, the fiber has rough texture and is poorly dyed. If more than 65 wt %, the fiber tends to be not voluminous because of the sticky texture, and must be subjected to finishing such as the polishing process under special conditions, undesirably.

The acrylonitrile content of the copolymer (II) is preferably 0 to 90 wt %, and more preferably 10 to 70 wt %. If the content is more than 90 wt %, it tends to be difficult to dye the fiber to medium to deep colors at 55 to 85° C. The content of the sulfonic acid group-containing monomer of the copolymer (II) is preferably 2 to 40 wt %, and more preferably 5 to 30 wt %. If the content is less than 2 wt%, it is difficult to dye the fiber to medium to deep colors at 55 to 85° C. If more than 40 wt %, the fiber tends to be agglutinated and eluted into the bath in the spinning process, undesirably.

Examples of the other vinyl monomer not containing halogen in the copolymer (II) include acrylic acid, methacrylic acid or their alkyl esters; vinyl acetate, acrylamide, 2-hydroxyethyl methacrylate, 2-hydroxyethyl acrylate, glycidyl methacrylate and glycidyl acrylate. Vinyl acetate and methyl acrylate are preferable in terms of quality and cost. The content of the other vinyl monomer not containing halogen in the copolymer (II) is preferably 0 to 80 wt %, and more preferably 10 to 60 wt %. If the content is more than 80 wt %, the fiber tends to have decreased heat resistance and to be agglutinated in the spinning process.

In the present invention, an acrylic fiber obtained by wet spinning such an acrylic copolymer is dyed. The dyeing temperature is preferably 55 to 85° C., and more preferably 63 to 80° C. Dyeing of a conventional acrylic fiber is drastically initiated and enhanced at a dyeing temperature of 70 to 80° C. If the fiber is dyed at a temperature of more than 85° C., the acrylic shrinkable fiber shrinks by heated water in a dye bath, and cannot shrink in dry heat treatment, making to difficult to obtain a pile fabric having a significant pile step. Although the dyeing time is not specifically limited, the dyeing time is preferably less than two hours, and more preferably about 30 to 90 minutes in general.

The fiber is preferably dyed with a cationic dye in terms of dyeability and color appearance after dyeing of the acrylic shrinkable fiber and fastness. A conventionally known cationic dye can be used without specific limitations. Examples include Maxilon series manufactured by Ciba Specialty Chemicals Inc. and Cathilon series manufactured by Hodogaya Chemical Co., Ltd. There are no specific limitations to the amount of the cationic dye used. However, at a dyeing temperature within the above range, the amount is preferably 0.1 to 30 parts by weight based on 100 parts by weight of the acrylic shrinkable fiber, in terms of practical use as well. It is not particularly necessary to use a dyeing promoter, but a conventionally known dyeing promoter may be used according to examples in the prior art. A conventional dyeing machine can also be used.

The acrylic shrinkable fiber obtained by dyeing is blended with a non-shrinkable fiber, and the mixture is carded. Subsequently, a pile fabric is prepared in a sliver knitting machine. Although there are no specific limitations to the material of a fiber used as the non-shrinkable fiber, it is preferable to use an acryl fiber or acrylic fiber in terms of crimp removability in the high pile finishing process and texture in the final pile goods. These may be used in a mixture of two or more. The acrylic shrinkable fiber is added to the pile fabric preferably in an amount of 20 to 80 wt %, and more preferably 30 to 70 wt %. If the amount is less than 20 wt %, a visually apparent pile step cannot be provided when the down hair part in the step pile fabric is relatively lightly colored. If more than 80 wt %, the area of the guard hair part is extremely small, the guard hair part and the down hair part are not balanced, and thus the commercial value of the step pile fabric tends to be impaired due to problems such as permanent set in fatigue.

Next, the pile fabric is treated by prepolishing and preshearing at 120° C. to make the pile length uniform, and then allowed to pass through a pin tenter dry heating machine to carry out dry heat treatment, so that the acrylic shrinkable fiber shrinks. The step pile fabric of the present invention is thus obtained. The dry heat treatment is carried out preferably at 110 to 150° C., and more preferably 130 to 145° C. If the dry heat treatment is carried out at less than 110° C., the acrylic shrinkable fiber insufficiently shrinks, so that a pile fabric having a significant pile step cannot be obtained. If the dry heat treatment is carried out at more than 150° C., crimps remaining in the fiber forming the pile part of the pile fabric are set by heat, and it is difficult to remove crimps in the subsequent polishing process, whereby problems such as deterioration in quality of the final product and a decrease in productivity tend to occur. The treatment time is preferably 20 minutes or less, and more preferably 3 to 10 minutes depending on the temperature. If the treatment time is too short, the shrinkable fiber cannot sufficiently shrink, and it tends to be difficult to observe an apparent pile step. If the treatment time is too long, the pile part fiber is colored yellow and hardened, undesirably.

The shrinkage percentage by dry heat treatment of the acrylic shrinkable fiber calculated by the above formula (1) is 18% or more, and preferably 25 to 35%. If the shrinkage percentage is less than 18%, a step pile fabric having a significant pile step cannot be obtained. The upper limit is not specifically limited. However, if the shrinkage percentage is more than 50%, the fibers in the pile part shrink while winding each other, and thus quality of the final product tends to involve a rough bottom part and poor fiber unraveling properties.

The pile back surface is preferably back-coated with an acrylic acid ester adhesive. Thereafter, polishing at 155° C. and subsequent brushing are carried out, and a combination of polishing and shearing at 135° C., 120° C. and 90° C. (repeating each process twice)to remove crimps in the plush surface part. Thus, a step pile fabric having a certain pile length can be obtained.

The step pile fabric of the present invention can readily assort an increased number of colors in the down hair part, and can be used for clothes such as fake fur, toys typified by stuffed toys, or interior goods, for example.

### EXAMPLES

The present invention will be specifically described below by way of examples. However, the present invention is not limited thereto.

(Analysis Measurement Conditions and Evaluation Methods)

(A) Measurement of Shrinkage Percentage of Acrylic Shrinkable Fiber by Dyeing

The fiber lengths of 20 acrylic shrinkable fibers before and after dyeing were measured to determine the average. The shrinkage percentage was calculated by the following formula:
Shrinkage percentage of acrylic shrinkable fiber by dyeing ( % )=[(Db−Da)/Db]×100

wherein Db represents a length of the shrinkable fiber before dyeing(mm), and Da represents a length of the shrinkable fiber after dyeing(mm).

A cut fiber with a short cut length was measured by enlarging the image of the acrylic shrinkable fiber using a copier or the like.

(B) Dyeing Performance Sensory Evaluation

Evaluations of dyeing and color appearance at each concentration were carried out from the visual and sensory points of view in the following standards.

Very good: Color appearance corresponding to the dyeing concentration is achieved.

Good: Color appearance nearly corresponding to the dyeing concentration is achieved.

Fair: Color appearance sufficiently corresponding to the dyeing concentration is not achieved.

Poor: There is a great difference between the dyeing concentration and the color appearance.

(C) Measurement of Shrinkage Percentage of Down Hair Part (Component) Before and After Dry Heat Treatment With Pin Tenter

The shrinkage percentage of the acrylic shrinkable fiber forming the down hair part in the step pile fabric was measured by allowing the fiber forming the pile part in the pile fabric before and after dry heat treatment with a pin tenter to vertically stand so as to make the naps uniform, and then using a vernier caliper. Specifically, the lengths between the bottom of the fiber forming the down hair part (component) in the pile part and the top of the down hair (not the length from the back surface of the pile fabric) was measured at 10 locations to determine the average. The shrinkage percentage was calculated by the following formula:
Shrinkage percentage (%)=100×(1−Sa/Sb)

wherein Sb represents a pile length(mm) of the down hair part before the dry heat treatment with a pin tenter, and Sa represents a pile length(mm) of the down hair part after the dry heat treatment with a pin tenter.

The pile part in the present invention refers to a plush part excluding the part of base fabric (ground threads) in the pile fabric (plush fabric).

(D) Hue Performance Evaluation

Sensory evaluation of hue of the down hair part in the pile fabric prepared in the manner as above was carried out from the visual and sensory points of view in the following standards.

Good: The shrinkable fiber is sufficiently dyed, and a target hue as down hair is expressed.

Fair: The shrinkable fiber is dyed, but a target hue as down hair is not sufficiently expressed.

Poor: The shrinkable fiber is not sufficiently dyed, and a target hue as down hair cannot be expressed.

(E) Pile Step Appearance Sensory Evaluation

Sensory evaluation of the degree of step of the pile fabric prepared in the manner as above as a step pile fabric was carried out from the visual and sensory points of view in the following standards.

Good: An sufficiently apparent step can be confirmed as a step pile.

Fair: The pile fabric is a step pile but with a boundary difficult to be confirmed between two layers.

Poor: The pile fabric has mixed appearance in which no apparent step can be confirmed.

### Production Examples 1 to 5

An acrylic copolymer comprising acrylonitrile (AN), vinyl acetate (VAc) and sodium styrenesulfonate (3S) in a composition described in Table 1 was dissolved in dimethylformamide (DMF) to prepare a spinning solution. The spinning solution was spun through a spinneret with 15,000 holes having a diameter of 0.08 mm into a coagulation bath of DMF/water=40/60 ( wt % ) at 30° C., and spin drawn at a ratio of 2.1(times) through five wash drawing baths having solvent concentrations sequentially decreased. Thereafter, the resulting fiber was provided with an oil, dried in an atmosphere at 120° C., and drawn at a ratio of 1.7 with a heat roller in a dry heat atmosphere of 120° C. Further, the resulting fiber was mechanically crimped to obtain a fiber having a final size of 4.4 dtex. The fiber thus obtained was cut into a 32 mm fiber. An Obermeyer dyeing machine was packed with the fiber at a fiber packing density of 0.30 g/cm³, and the fiber was heated from room temperature at a rate of 3° C./min. When the temperature reached 50° C., a dye was added according to the following dyeing formulation.

0.9% omf dyeing formulation

Maxilon Golden Yellow 2RL 200%: 0.60% omf

Maxilon Red GRL 200%: 0.15% omf

Maxilon Blue GRL 300%: 0.15% omf

1.8% omf dyeing formulation

Maxilon Golden Yellow 2RL 200%: 1.20% omf

Maxilon Red GRL 200%: 0.30% omf

Maxilon Blue GRL 300%: 0.30% omf

(All manufactured by Ciba Specialty Chemicals, Inc.)

The fiber was subsequently heated to dyeing temperatures respectively described in Table 1, and maintained at that temperature for 60 minutes. After completion of dyeing, the dyeing solution was cooled. The dyed fiber was taken out, dehydrated by centrifugation, and then dried in a dryer at 60° C. The shrinkage percentage by dyeing was measured and the dyeing performance was evaluated for each fiber. The results are shown in Table 1.

### Production Examples 6 to 7

A copolymer (I) comprising acrylonitrile (AN)/vinyl chloride (VCL)/sodium styrenesulfonate (3S)=49.5/50/0.5 ( wt % ) and a copolymer (II) comprising acrylonitrile (AN)/methyl acrylate (MA)/sodium 2-acrylamido-2-methylpropanesulfonate (SAM)=30/55/15 ( wt % ) were prepared. 92 parts by weight of the copolymer (I) was mixed with 8 parts by weight of the copolymer (II), and the mixture was dissolved in acetone (Ac) to prepare a spinning solution. The spinning solution was spun through the same spinneret as in Production Examples 1 to 5 into a coagulation bath of Ac/water=30/70 ( wt % ) at 30° C., and spin drawn at a ratio of 2.1 through five wash drawing baths having solvent concentrations sequentially decreased. The resulting fiber was provided with an oil, dried in an atmosphere at 115° C., and drawn at a ratio of 1.8 with a heat roller in a dry heat atmosphere of 115° C. Further, the resulting fiber was mechanically crimped to obtain a fiber having a final size of 4.4 dtex.

The fibers obtained in this manner were dyed in the same manner as in Production Examples 1 to 5, except that the dyeing temperatures were as described in Table 1. The shrinkage percentage by dyeing was measured and the dyeing performance was evaluated for each of the resulting fibers. The results are shown in Table 1.

### Production Example 8

A copolymer (I) comprising acrylonitrile (AN)/vinyl acetate (VAc)/sodium methallylsulfonate (MS)=85/14.7/0.3 ( wt % ) and a copolymer (II) comprising acrylonitrile (AN)/methyl acrylate (MA)/sodium 2-acrylamido-2-methylpropanesulfonate (SAM)=40/45/15 ( wt % ) were prepared. 92 parts by weight of the copolymer (I) was mixed with 8 parts by weight of the copolymer (II), and the mixture was dissolved in dimethylacetamide (DMAc) to prepare a spinning solution. A fiber having a final size of 4.4 dtex was obtained using the same spinneret as in Production Examples 1 to 5 under the same spinning conditions.

The fiber thus obtained was cut into a 32 mm fiber. An Obermeyer dyeing machine was packed with the fiber at a fiber packing density of 0.30 g/cm³, and the fiber was heated from room temperature at 3° C./min. When the temperature reached 50° C., a dye was added according to the same dyeing formulation as in Production Examples 1 to 5. The dyeing machine was subsequently heated to 70° C. and then maintained at that temperature for 60 minutes. Further, after completion of dyeing, the dyeing solution was cooled. The dyed fiber was taken out, dehydrated by centrifugation, and then dried in a dryer at 60° C. The shrinkage percentage by dyeing was measured and the dyeing performance was evaluated for the resulting fiber. The results are shown in Table 1.

### Production Examples 9 and 10

An acrylic copolymer comprising acrylonitrile (AN)/vinyl acetate (VAc)/sodium methallylsulfonate (MS)=85/14.7/0.3 ( wt % ) was dissolved in dimethylacetamide (DMAc) to prepare a spinning solution. The spinning solution was spun through a spinneret with 15,000 holes having a diameter of 0.08 mm into a coagulation bath of DMAc/water=40/60 ( wt % ) at 30° C., and spin drawn at a ratio of 3.0 through five wash drawing baths having solvent concentrations sequentially decreased. Then, the resulting fiber was provided with an oil and then dried in an atmosphere at 125° C. Then, the fiber was relaxed in a heated steam under pressure at 135° C., and drawn at a ratio of 1.8 with a heat roller in a dry heat atmosphere at 120° C. Further, the resulting fiber was mechanically crimped to obtain a fiber having a final size of 4.4 dtex. The fibers obtained in this manner were dyed in the same manner as in Production Examples 1 to 5, except that the dyeing temperatures were as described in Table 1. The shrinkage percentage by dyeing was measured and the dyeing performance was evaluated for each of the resulting fibers. The results are shown in Table 1.

TABLE 1

| | | | | | | Shrinkage | | |
|---|---|---|---|---|---|---|---|---|
| | | | | | Dyeing | percentage | 0.5% dyeing | 1% dyeing |
| | Copolymer composition | | Process | Fiber | temperature | during dyeing | performance | performance |
| | ratio (wt %) | Solvent | stability | agglutination | (° C.) | (%) | evaluation | evaluation |
| Production | AN/VAc/3S = 79/19.5/1.5 | DMF | G | G | 70 | 1 | VG | G |
| Example 1 | | | | | | | | |
| Production | AN/VAc/3S = 79/19.5/1.5 | DMF | G | G | 80 | 17 | VG | VG |
| Example 2 | | | | | | | | |
| Production | AN/VAc/3S = 79/19.5/1.5 | DMF | G | G | 100 | 30 | VG | VG |
| Example 3 | | | | | | | | |
| Production | AN/VAc/3S = 93/2/5 | DMF | G | G | 70 | 1.5 | VG | VG |
| Example 4 | | | | | | | | |
| Production | AN/VAc/3S = 93/2/5 | DMF | G | G | 95 | 27 | VG | VG |
| Example 5 | | | | | | | | |
| Production | AN/VCL/VAc/3S + SAM = | Ac | G | G | 70 | 6 | VG | VG |
| Example 6 | 47.94/46/4.4/1.66 | | | | | | | |
| Production | AN/VCL/VAc/3S + SAM = | Ac | G | G | 63 | 2 | VG | G |
| Example 7 | 47.94/46/4.4/1.66 | | | | | | | |
| Production | AN/VAC/MA/MS + SAM = | DMF | G | G | 70 | 3 | G | G |
| Example 8 | 81.40/13.52/3.60/1.48 | | | | | | | |
| Production | AN/VAc/MS = 85/14.7/0.3 | DMAc | G | G | 70 | 13 | P | P |
| Example 9 | | | | | | | | |
| Production | AN/VAC/MS = 85/14.7/0.3 | DMAc | G | G | 80 | 28 | P | P |
| Example 10 | | | | | | | | |

AN: Acrylonitrile
VAc: Vinyl acetate
VCL: Vinyl chloride
MA: Methyl acrylate
3S: Sodium styrenesulfonate
SAM: Sodium 2-acrylamido-2-methylpropanesulfonate
MS: Sodium methallylsulfonate
DMF: Dimethylformamide
Ac: Acetone
DMAc: Dimethylacetamide

### Examples 1 to 8 and Comparative Examples 1 to 5

Next, step pile fabrics were prepared using the fibers obtained in Production Examples 1 to 10. Each fiber was dyed with a 0.9% omf dyeing formulation.

70 parts by weight of the acrylic shrinkable fiber obtained in Production Examples 1 to 10 was blended with 30 parts by weight of a commercially available acrylic fiber “Kanecaron (R)” RLM (BBR807) 12 dtex, 44 mm (manufactured by Kaneka Corporation) to prepare a pile fabric. The pile fabric was prefinished using a pin tenter dryer at temperatures respectively described in Table 2 for five minutes. The shrinkage percentage of the down hair part was measured and the hue performance and the step appearance of the down hair part were evaluated for the resulting step pile fabric. The results are shown in Table 2. Each of the step pile fabrics prepared in this manner had a final basis weight of 680 g/m² and an average pile length of 18 mm.

TABLE 2

| | | | | Pin tenter dryer | | | |
|---|---|---|---|---|---|---|---|
| | | Average pile | Basis weight | temperature and shrinkage | | | Pile step |
| | Ratio of fibers used | length | of pile fabric | percentage | | Hue | appearance |
| | (part(s) by weight) | (mm) | (g/m²) | (° C.) | (%) | performance | evaluation |
| Example 1 | RLM/Production | 18 | 680 | 115 | 20 | G | G |
| | Example 1 = 30/70 | | | | | | |
| Example 2 | RLM/Production | 18 | 680 | 130 | 28 | G | G |
| | Example 1 = 30/70 | | | | | | |
| Example 3 | RLM/Production | 18 | 680 | 145 | 35 | G | G |
| | Example 1 = 30/70 | | | | | | |
| Example 4 | RLM/Production | 18 | 680 | 130 | 18 | G | G |
| | Example 2 = 30/70 | | | | | | |
| Example 5 | RLM/Production | 18 | 680 | 130 | 26 | G | G |
| | Example 4 = 30/70 | | | | | | |
| Example 6 | RLM/Production | 18 | 680 | 130 | 30 | G | G |
| | Example 6 = 30/70 | | | | | | |
| Example 7 | RLM/Production | 18 | 680 | 130 | 35 | G | G |
| | Example 7 = 30/70 | | | | | | |
| Example 8 | RLM/Production | 18 | 680 | 130 | 25 | G | G |
| | Example 8 = 30/70 | | | | | | |
| Comparative | RLM/Production | 18 | 680 | 105 | 11 | G | P |
| Example 1 | Example 1 = 30/70 | | | | | | |
| Comparative | RLM/Production | 18 | 680 | 130 | 1 | G | P |
| Example 2 | Example 3 = 30/70 | | | | | | |
| Comparative | RLM/Production | 18 | 680 | 130 | 2 | G | P |
| Example 3 | Example 5 = 30/70 | | | | | | |
| Comparative | RLM/Production | 18 | 680 | 130 | 12 | P | P |
| Example 4 | Example 9 = 30/70 | | | | | | |
| Comparative | RLM/Production | 18 | 680 | 130 | 3 | P | P |
| Example 5 | Example 10 = 30/70 | | | | | | |

The step pile fabrics obtained in Examples 1 to 8 were step pile fabrics having an apparent step as shown in Table 2. On the other hand, in the step pile fabrics obtained in Comparative Examples 1 to 3, no steps as step pile fabrics was not observed. The step pile fabrics obtained in Comparative Examples 4 and 5 had pile steps as step pile fabrics. However, the fabrics did not show the target hue as down hair because the shrinkable fiber could not be sufficiently dyed, and could not express a target hue as down hair.

Industrial Applicability

An increased number of colors can be assorted in the down hair part of a step pile fabric easier than before by carrying out dry heat treatment of a pile fabric comprising an acrylic shrinkable fiber that can be dyed in a low-temperature region. Since an acrylic shrinkable fiber used in the down hair part in a step pile fabric can be dyed as well, the customer can reduce the inventory of a spun-dyed shrinkable fiber and can perform economical inventory management.

1. A step pile fabric obtained by treating a pile fabric comprising an acrylic shrinkable fiber, which comprises an acrylic copolymer comprising 0.5 to 10 wt % of a sulfonic acid group-containing monomer, dyed at 55 to 85° C., with dry heat at 110 to 150° C. for 20 minutes or less, the acrylic shrinkable fiber having a shrinkage percentage of 18% or more calculated by the following formula (1):
Shrinkage percentage ( % )=100×(1−Sa/Sb) (1)
wherein Sb represents a pile length of the down hair component before the thy heat treatment, and Sa represents a pile length of the down hair part (component) after the dry heat treatment.

2. The step pile fabric according to claim 1, wherein the acrylic shrinkable fiber comprises an acrylic copolymer and is dyed with a cationic dye.

3. The step pile fabric according to claim 1 wherein the acrylic copolymer comprises 60 to 99 parts by weight of a copolymer (I) comprising 35 to 98 wt % of acrylonitrile, 0 to 5.0 wt % of a sulfonic acid group-containing monomer and 2 to 65 wt % of other vinyl monomer(s), and 1 to 40 parts by weight of a copolymer (II) comprising 0 to 90 wt % of acrylonitrile, 2 to 40 wt % of a sulfonic acid group-containing monomer and 0 to 80 wt % of other vinyl monomer(s), wherein the copolymers (I) and (II) are 100 parts by weight in total.

4. A process for producing the step pile fabric according to claim 1, comprising the steps of: dyeing an acrylic shrinkable fiber comprising an acrylic copolymer comprising 0.5 to 10 wt % of a sulfonic acid group-containing monomer at 55 to 85° C.; blending the acrylic shrinkable fiber with a non-shrinkable fiber to produce a pile fabric; and treating the resulting pile fabric with dry heat at 110 to 150° C. for 20 minutes or less to cause the acrylic shrinkable fiber to have a shrinkage percentage of 18% or more.

5. The step pile fabric according to claim 2, wherein the acrylic copolymer comprises 60 to 99 parts by weight of a copolymer (I) comprising 35 to 98 wt % of acrylonitrile, 0 to 5.0 wt % of a sulfonic acid group-containing monomer and 2 to 65 wt % of other vinyl monomer(s), and 1 to 40 parts by weight of a copolymer (II) comprising 0 to 90 wt % of acrylonitrile, 2 to 40 wt % of a sulfonic acid group-containing monomer and 0 to 80 wt % of other vinyl monomer(s), wherein the copolymers (I) and (II) are 100 parts by weight in total.

6. A process for producing the step pile fabric according to claim 2, comprising the steps of: dyeing an acrylic shrinkable fiber comprising an acrylic copolymer comprising 0.5 to 10 wt % of a sulfonic acid group-containing monomer at 55 to 85° C.; blending the acrylic shrinkable fiber with a non-shrinkable fiber to produce a pile fabric; and treating the resulting pile fabric with dry heat at 110 to 150° C. for 20 minutes or less to cause the acrylic shrinkable fiber to have a shrinkage percentage of 18% or more.

7. A process for producing the step pile fabric according to claim 3, comprising the steps of: dyeing an acrylic shrinkable fiber comprising an acrylic copolymer comprising 0.5 to 10 wt % of a sulfonic acid group-containing monomer at 55 to 85° C.; blending the acrylic shrinkable fiber with a non-shrinkable fiber to produce a pile fabric; and treating the resulting pile fabric with dry heat at 110 to 150° C. for 20 minutes or less to cause the acrylic shrinkable fiber to have a shrinkage percentage of 18% or more.
